(19) United States
(12) Patent Application Publication
(10) Pub. No.: US 2014/0372402 A1
(43) Pub. Date: Dec. 18, 2014

(54) Enhanced Searching at an Electronic Device

(71) Applicant: Acer Incorporated, New Taipei City (TW)

(72) Inventor: Jhao-Dong Chiu, New Taipei City (TW)

(73) Assignee: Acer Incorporated, New Taipei City (TW)

(21) Appl. No.: 14/011,996

(22) Filed: Aug. 28, 2013

(30) Foreign Application Priority Data
Jun. 18, 2013 (TW) 102121597

(51) Int. Cl. G06F 17/30

(52) U.S. Cl. CPC G06F 17/30864
USPC 707/706; 707/769

(57) ABSTRACT

Presented herein are enhanced techniques for searching content using an electronic device. In accordance with the enhanced searching techniques, the electronic device detects a user's selection of information displayed at the electronic device. The electronic device subsequently detects that the user has dragged the selected information to a search field displayed at the electronic device and automatically identifies the information type. The electronic device conducts a search of a search space based on the selected information dragged into the search field, wherein the search is specific for the information type.

### RELATED APPLICATION DATA

This application claims priority under 35 U.S.0 119 to Taiwan patent application, TW 102121597, filed on Jun. 18, 2013, the disclosure of which is incorporated herein by reference.

### TECHNICAL FIELD

### Background

There are currently a wide range of electronic devices available to users. One category of electronic devices is referred to herein as portable electronic devices or portable computing devices. Portable electronic devices provide users with a relatively small and convenient device that can run various applications/programs within different environments. Portable electronic devices include, but are not limited to, mobile phones, tablet computers, laptops, personal digital assistants (PDAs), etc.

An electronic device typically includes one or more network interfaces that enable the device to connect to a network, such as a local area network (LAN) (e.g., a corporate Intranet) and/or a wide area network (WAN) (e.g., the Internet). Additionally, portable electronic devices typically have one or more interfaces through which a user can interact with the device.

### SUMMARY

In accordance with certain embodiments, techniques for searching content using an electronic device are presented herein. In accordance with the presented techniques, the electronic device detects a user's selection of information displayed at the electronic device. The electronic device subsequently detects that the user has dragged the selected information to a search field displayed at the electronic device and automatically identifies the information type. The electronic device conducts a search of a search space based on the selected information dragged into the search field, wherein the search is specific for the information type.

### BRIEF DESCRIPTION OF THE DRAWINGS

Embodiments are described herein in conjunction with the accompanying drawings, in which:

FIGS. 1-3 are schematic diagrams of an electronic device configured to execute enhanced searching techniques in accordance with embodiments presented herein.

FIG. 4 is a flowchart of an enhanced searching method in accordance with embodiments presented herein.

FIG. 5 is a flowchart of an enhanced searching method in accordance with embodiments presented herein.

FIG. 6 is a block diagram of an electronic device configured to execute enhanced searching techniques in accordance with embodiments presented herein.

### DESCRIPTION OF EXAMPLE EMBODIMENTS

A user generally initiates a search at an electronic device by adding text to a search field displayed at a user interface of the electronic device. In certain conventional arrangements, a user adds text to a search field using the well-known cut/copy and paste functions. Presented herein are enhanced searching techniques that eliminate the need to use these conventional cut/copy and paste functions. More specifically, the enhanced searching techniques presented herein enable a user to select various types of information (e.g., text, images, image portions, etc.) through, for example, one or more touch inputs. The enhanced searching techniques also allow the user to drag the selected information to a search field. Once the selected information is dragged into the search field, the enhanced searching techniques enable the electronic device to recognize/identify the information type (i.e., text, image, etc.) and initiate a search that is specific for that information type. In other words, the enhanced searching techniques enable the electronic device to initiate a text search if text is added to the search field or an image search if an image is added to the search field. The enhanced searching techniques may also implement text recognition techniques where an image-based text representation (i.e., part of an image that represents text) is converted to actual text and used in a subsequent text search.

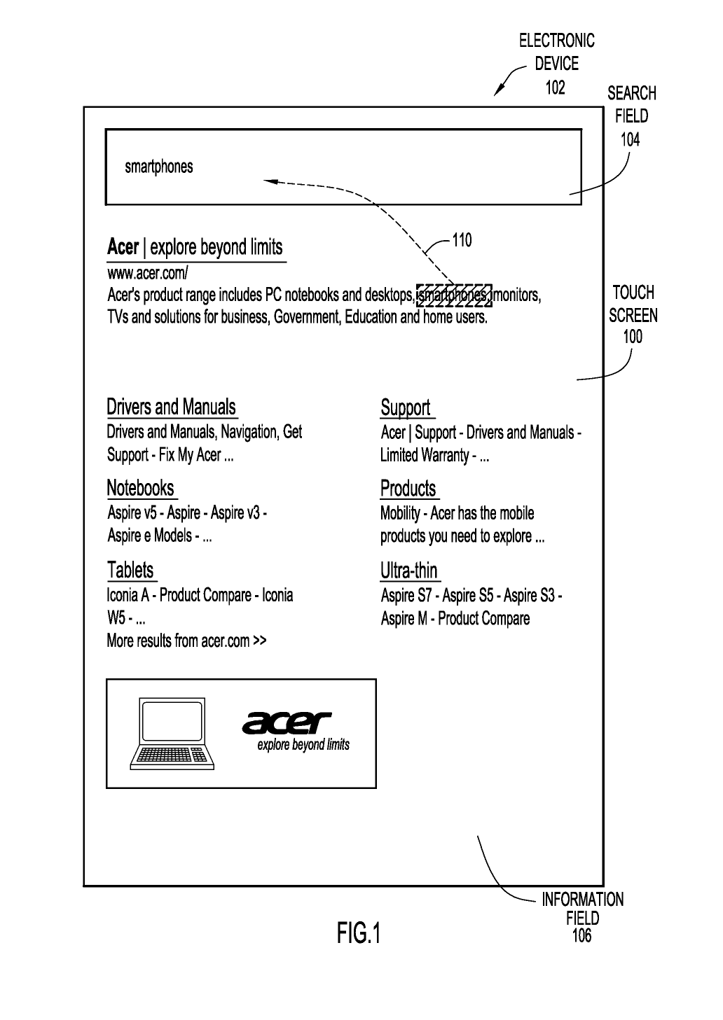

FIGS. 1-3 are schematic diagrams depicting a screen 100 of an electronic device 102 configured to execute enhanced searching techniques in accordance with embodiments presented herein. The electronic device 102 may be, for example, a tablet computing device, mobile phone, personal digital assistant (PDA), desktop computer, laptop computer, etc. The screen 100 is a “touch screen” that includes an information section/field 106 and a search section/field 104. The information field 106 is configured to display information (e.g., text, images, etc.) to a user. The search field 104, sometimes referred to as a search menu or search bar, enables the user to perform searches within a predetermined search space. The predetermined search space may be, for example, a corporate Intranet, the World Wide Web, memory of the electronic device 102, etc.

Touch screen 100 comprises a touch sensor/panel that is positioned on front of, or integrated with, a display screen. Touch screen 100 is configured to recognize touch inputs of a user and determine the location of the touch input. The touch screen 100 connects a pressure point of the touch panel with a corresponding point on the display screen, thereby providing the user with an intuitive connection with the screen. The touch input may be, for example, physical contact via a finger, a stylus, etc.

As noted, the electronic device of FIGS. 1-3 includes a touch screen 100. It is to be appreciated that the electronic device 102 may also include other types of user interfaces, such as, for example, a keyboard, a mouse, a trackpad, etc., and that these different user interfaces may be used in the enhanced searching techniques to select information and drag that information to search field 104. These alternative user interfaces have, for ease of illustration, been omitted from FIGS. 1-3.

Also as noted, the touch screen 100 may display information (e.g., text and/or images) within the information field 106. In accordance with embodiments presented herein, a user may select information displayed at the touch screen 100 and drag the selected information to the search field 104. As described further below, once the information is added to the search field 104, the electronic device 102 may perform a search based on the information.

FIG. 1 illustrates an example in which a user selects some text displayed within the information field 106. More specifically, in the example of FIG. 1, the user selects the word “smartphones” by touching that word on the touch screen 100 with, for example, a finger or stylus. When the user touches the word “smartphones” (either via a single touch or a so-called “double-click”), the electronic device “highlights” that word. In other words, the electronic device 102 is configured such that the user's touch at a portion of the word causes the entire word to be highlighted. The selection and highlighting of a word in response to one or more user touches is known and not discussed further herein.

After the user highlights the word “smartphones,” the user then drags the highlighted word into the search field 104. In general, the user touches the word “smartphones” (to cause the selection of that word) and, without removing his/her finger or stylus from the touch screen, drags the highlighted text to the search field 104 and releases his/her touch (i.e., removes his/her finger or stylus from the touch screen 100). This drag operation is shown in FIG. 1 by arrow 110.

After completion of the dragging operation, the word “smartphones” appears in the search field 104. In certain embodiments, text dragged to the search field 104 may replace information previously present in the search field. Alternatively, the text dragged to the search field 104 may be appended to information previously present in the search field. In one example, the decision of whether the text should replace or be appended to information already in the search field 104 may depend on where the user releases the touch (e.g., a release of the touch at or near the beginning of the search field may cause all previous information to be replaced, while a release of the touch at or near the end of the search field may cause the text to be appended to the previous information).

In accordance with the enhanced searching techniques presented herein, the electronic device 102 is configured to automatically identify/determine the “type” of information that is dragged into the search field 104. That is, as described further below, the electronic device 102 determines if the information that is dragged into the search field 104 is text or an image. Also as described further below, if an image is dragged into the search field 104, the electronic device 102 may be configured to automatically determine if part of the image represents text and, if so, implement text recognition techniques to convert the text representation into text.

In the embodiment of FIG. 1, the electronic device 102 recognizes that text has been dragged into the search field 104. Accordingly, the electronic device 102 uses the text to conduct a text search of a predetermined search space that is associated with the search field 104. The search may be initiated automatically upon completion of the drag/drop and determination operations noted above.

FIG. 1 illustrates an example in which the word “smartphones” is selected in response to a touch of the user at the word. It is to be appreciated that other selection techniques known in the art may be used in alternative embodiments. For example, in one alternative embodiment the user may select the word “smartphones” by dragging his or her finger from the beginning of the word to the end of the word (or vice versa). In another embodiment, the user may select the word “smartphones” by drawing a circle around the word.

FIG. 1 has been described with specific reference to the selection of the single word “smartphones.” It is to be appreciated that the user could alternatively select other words. Additionally, instead of selecting a single word, a user could alternatively select phrases, sentences, paragraphs, etc., and drag that selected information to the search field 104. In such embodiments, the entire phrase, sentence, paragraph, etc., may form the basis for the subsequent search.

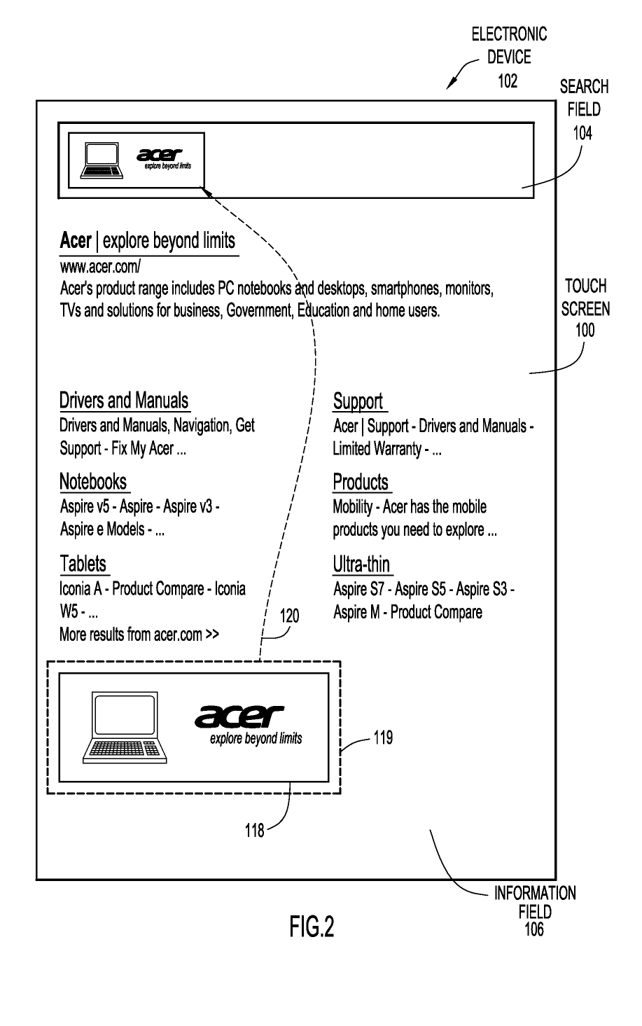

FIG. 2 illustrates another example in which, instead of selecting text from the information field 106, the user selects an image from the information field 106. More specifically, in the example of FIG. 2, the user selects the image identified by reference number 118 by “circling” the entire image. That is, the user uses touch inputs (e.g., finger or stylus) to draw a generally closed polygonal shape 119 (that is not necessarily a circle) around the image 118.

After the user selects image 118, the user then drags the selected image into the search field 104. In general, the user selects image 118 and, without removing his/her finger or stylus from the touch screen 100, drags the selected image to the search field 104 and releases his/her touch (i.e., removes his/her finger or stylus from the touch screen 100). This drag operation is shown in FIG. 2 by arrow 120.

After the completion of the dragging operation, the image 118 appears in the search field 104. In certain embodiments, the image 118 dragged to the search field 104 may replace information previously present in the search field. Alternatively, the image 118 dragged to the search field 104 may be appended to information previously present in the search field. In one example, the decision of whether the image 118 should replace or be appended to information already in the search field 104 may depend on where the user releases the touch (e.g., a release of the touch at or near the beginning of the search field may cause all previous information to be replaced, while a release of the touch at or near the end of the search field may cause the image 118 to be appended to the previous information).

As noted above, the electronic device 102 is configured to automatically identify/determine the type of information that is dragged into the search field 104. In the embodiments of FIG. 2, the electronic device 102 recognizes that it is an image that has been dragged into the search field 104 and the electronic device 102 initiates an image search of the search space associated with the search field 104 based on the added image. The search may be initiated automatically upon completion of the drag and determination operations noted above.

FIG. 2 illustrates an example in which the image 118 is selected by circling the image. It is to be appreciated that other selection techniques known in the art may be used in alternative embodiments. For example, in one alternative embodiment the user may select the image 118 by dragging his or her finger across the image. In another embodiment, the user may select image 118 through a single touch or double-click with, for example, a finger or stylus. In such embodiments, when the user touches the image 118 the electronic device highlights that image.

FIG. 2 has been described with specific reference to the selection of the single image 118. It is to be appreciated that the user could alternatively select other images. Additionally, instead of selecting a single image a user could alternatively select multiple images or one or more images in combination with words, phrases, sentences, paragraphs, etc. In examples in which an image and text is selected, the text, image, or both types of information may be used for the subsequent search. In certain examples, when both text and an image are selected and dragged to the search field 104, the electronic device 102 may instruct the user to select between a text and image search (i.e., the electronic device 102 notifies the user that both images and text have been added to the search field 104, and the user is instructed to select whether the text or image will be the basis for a subsequent search).

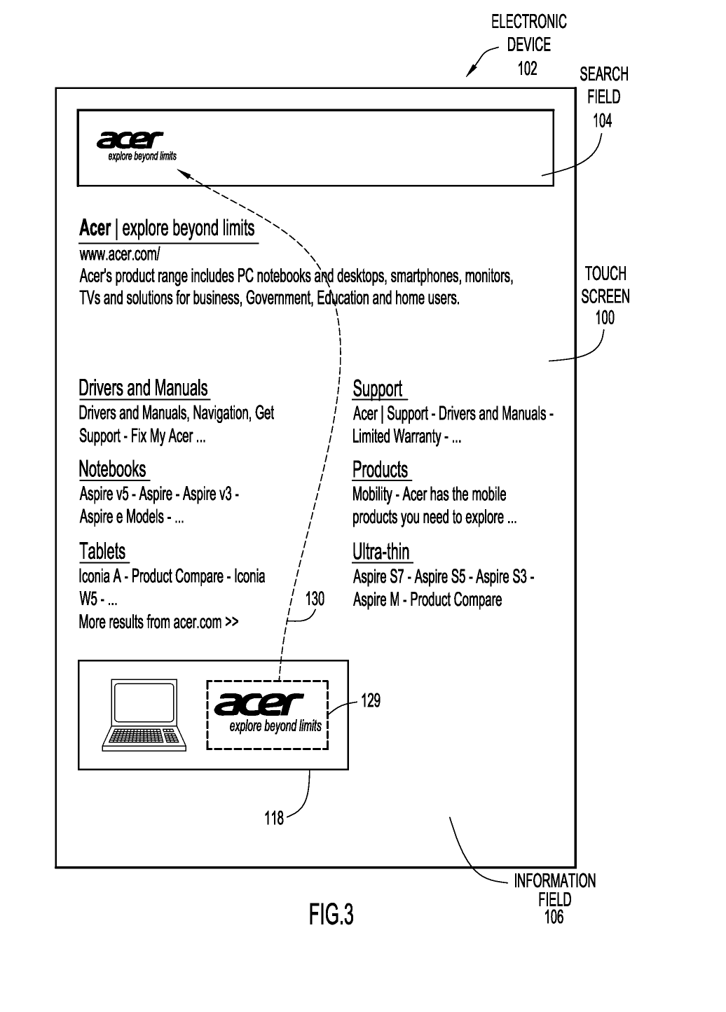

FIG. 3 illustrates a further example in which, instead of selecting an entire image within the information field 106, the user selects a portion of an image. More specifically, in the example of FIG. 3, the user selects a portion 128 of image 118 by “circling” the portion 128. That is, the user uses touch inputs (e.g., finger or stylus) to draw a generally closed polygonal shape 129 (that is not necessarily a circle) around the portion 128.

After the user selects portion 128, the user then drags the selected portion of the image 118 into the search field 104. In general, the user selects portion 128 and, without removing his/her finger or stylus from the touch screen 100, drags the selected portion to the search field 104 and releases his/her touch (i.e., removes his/her finger or stylus from the touch screen 100). This drag operation is shown in FIG. 3 by arrow 130.

After the completion of the dragging operation, the portion 128 of image 118 appears in the search field 104. In certain embodiments, the portion 128 dragged to the search field 104 may replace information previously present in the search field. Alternatively, the portion 128 dragged to the search field 104 may be appended to information previously present in the search field. In one example, the decision of whether the portion 128 should replace or be appended to information already in the search field 104 may depend on where the user releases the touch (e.g., a release of the touch at or near the beginning of the search field may cause all previous information to be replaced, while a release of the touch at or near the end of the search field may cause the portion 128 to be appended to the previous information).

In certain embodiments, the electronic device 102 automatically recognizes that it is an image that has been added to the search field 104 and the electronic device 102 initiates an image search of the search space associated with the search field 104 based on the added image. However, as shown in FIG. 3, the image portion 128 is an image-based text representation (i.e., the image portion represents text). As such, in these embodiments the electronic device 102 automatically determines that the image portion 128 represents text and, using text-recognition techniques known in the art, converts the image portion 128 to text. The electronic device 102 may then conduct a text search of the search space using this converted text.

FIG. 3 illustrates an example in which the portion 128 of image 118 is selected by circling the portion. It is to be appreciated that other selection techniques known in the art may be used in alternative embodiments.

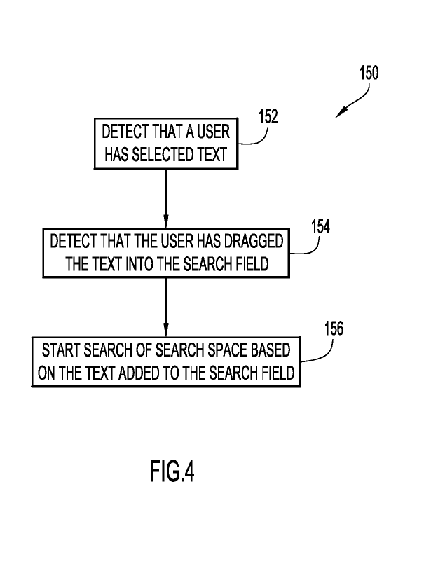

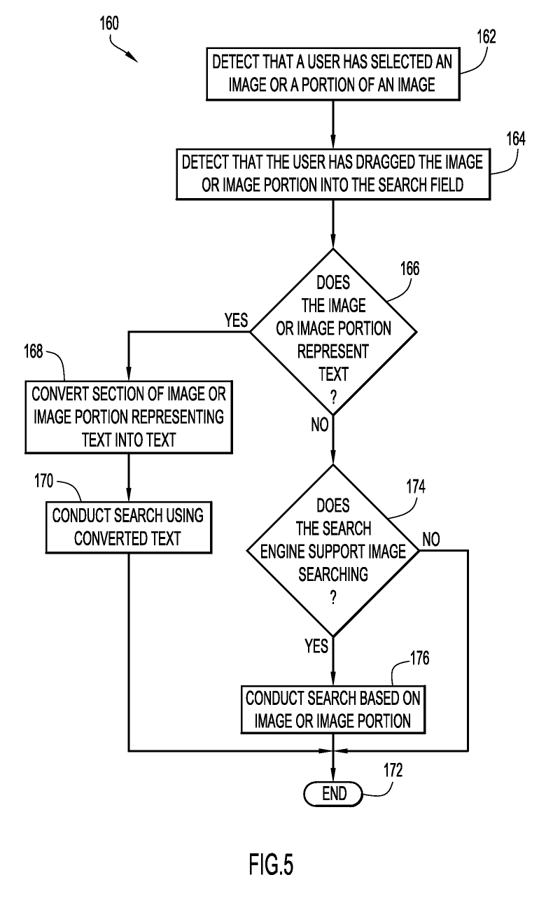

FIGS. 4 and 5 are flowcharts illustrating methods in accordance with embodiments presented herein. For ease of illustration, the methods of FIGS. 4 and 5 will be described with reference to electronic device 102 of FIGS. 1-3.

Referring first to method 150 of FIG. 4, the method begins at 152 where electronic device 102 detects that a user has selected text from information field 106. At 154, the electronic device detects that the user has dragged the selected text into the search field 104. After the selected text has been added to the search field, at 156 the electronic device 102 uses the selected text to conduct a text search of a predetermined search space.

The method 160 of FIG. 5 begins at 162 where the electronic device 102 detects that a user has selected an image or a portion of an image from information field 106. At 164, the electronic device detects that the user has dragged the image or the image portion into the search field 104.

Next, at 166, the electronic device 102 determines whether part of the image or image portion is an image-based text representation. If part of the image or image portion represents text, the method proceeds to 168 where the electronic device 102 converts the image-based text representation into actual text (using text recognition techniques as known). Subsequently, at 170, the electronic device 102 (i.e., the search engine associated with the search field 104) conducts a text search of a predetermined search space using the converted text. The method 160 then ends at 172.

Returning to 166, if the electronic device 102 determines that no part of the image or image portion is an image-based text representation, the method 160 proceeds to 174 where the electronic device 102 determines whether the search engine associated with the search field 104 supports image searching. If not, the method 160 ends at 172. In certain such embodiments, a notification may be provided to the user that such an image search is not supported. However, if the search engine does support image searching, then at 176 the electronic device 102 (i.e., the search engine associated with the search field 104) conducts a search of a predetermined search space using the image or image portion.

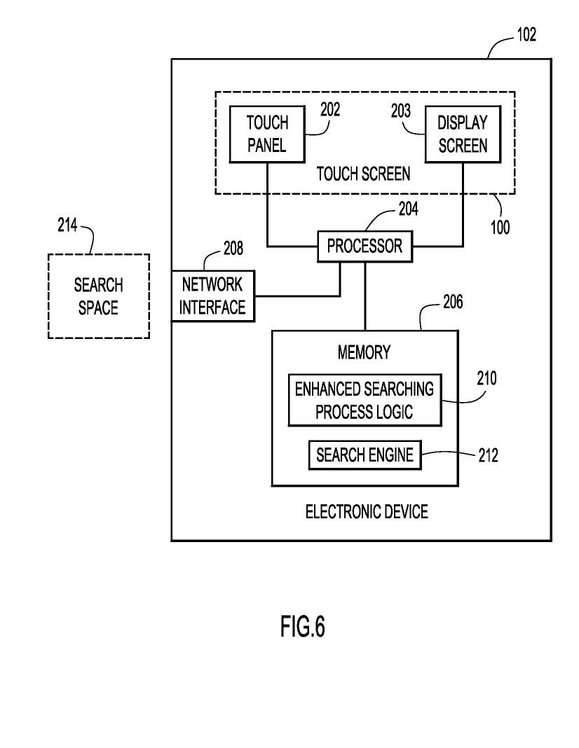

Reference is now made to FIG. 6 that shows a block diagram of the electronic device 102. The electronic device 102 comprises, among other features, a touch screen 100 that includes a touch sensor (panel) 202 that is positioned on front of, or integrated with, a display screen 203. The electronic device 102 also comprises a processor 204, a memory 206, and a network interface 208. The touch panel 202, display screen 203, memory 206, and network interface 208 are coupled to the processor 204.

The touch screen 100 is configured to display information (e.g., images and or text) as described above. The touch panel 202 is configured to receive one or more touch inputs from the user of the electronic device 102. For example, as described above, the touch panel 202 is configured to receive one or more physical contact (touch) instances from the user, a stylus, etc. The touch panel 202 and the display screen 203 may be implemented as an integrated unit.

The processor 204 is a microprocessor or microcontroller that is configured to execute program logic instructions (i.e., software) for carrying out various operations and tasks described herein. For example, the processor 204 is configured to execute enhanced searching process logic 210 that is stored in the memory 206 to perform the enhanced searching techniques/operations described elsewhere herein. The memory 206 may comprise read only memory (ROM), random access memory (RAM), magnetic disk storage media devices, optical storage media devices, flash memory devices, electrical, optical or other physical/tangible memory storage devices.

It is to be appreciated that the enhanced searching process logic 210 may take any of a variety of forms, so as to be encoded in one or more tangible computer readable memory media or storage device for execution, such as fixed logic or programmable logic (e.g., software/computer instructions executed by a processor). The processor 204 may be an application specific integrated circuit (ASIC) that comprises fixed digital logic, or a combination thereof. For example, the processor 204 may be embodied by digital logic gates in a fixed or programmable digital logic integrated circuit, in which digital logic gates are configured to perform the operations of the enhanced searching process logic 210.

As described above, a user of the electronic device 102 may initiate enhanced searching operations by selecting information displayed at touch screen 100. The user may then drag the selected information to a search field. The electronic device 102 (i.e., the enhanced searching process logic 210 executed by processor 204) identifies the type of information added to the search field and conducts a search using a search engine 212 of a predetermined search space 214. The search is specific for the type of information (i.e., a text search if text is added to the search field or an image search if an image is added to the search field). The search space 214 may be, for example, a corporate Intranet, the World Wide Web, memory of the electronic device 102, etc.

The enhanced searching techniques presented herein have one or more advantages. For example, the enhanced searching techniques presented may be implemented at portable electronic devices and may be implemented by an operating system (OS) as a default function. The enhanced searching techniques enable automated selection of text or image searching and improve the user's searching effectiveness.

The above description is intended by way of example only.

What is claimed is:

1. A method, comprising:
detecting that a user has selected information displayed at an electronic device;
detecting that the user has dragged the selected information to a search field displayed at the electronic device;
automatically identifying the information type; and
conducting a search based on the selected information dragged into the search field, wherein the search is specific for the information type.

2. The method of claim 1, wherein automatically identifying the information type comprises:
automatically identifying the information as text.

3. The method of claim 1, wherein automatically identifying the information type comprises:
automatically identifying the information as an image or an image portion.

4. The method of claim 3, further comprising:
determining that part of the image or image portion includes an image-based text representation;
converting the image-based text representation into actual text; and
conducting a text search of the search space using the actual text obtained through the conversion.

5. The method of claim 3, further comprising:
determining whether a search engine associated with the search field supports image searching.

6. The method of claim 1, wherein detecting that the user has selected information displayed at the electronic device comprises:
detecting touch inputs at a touch screen of the electronic device.

7. The method of claim 1, wherein detecting that the user has dragged the selected information to the search field comprises:
detecting that the user has dragged the selected information to a point near the beginning of the search field so as to cause information present in the search field to be replaced by the selected information.

8. The method of claim 1, wherein detecting that the user has dragged the selected information to the search field comprises:
detecting that the user has dragged the selected information to a point near the end of the search field so as to cause the selected information to be appended to information present in the search field.

9. One or more computer readable storage media encoded with software comprising computer executable instructions and when the software is executed operable to:
detect that a user has selected information displayed at an electronic device;
detect that the user has dragged the selected information to a search field displayed at the electronic device;
automatically identify the information type; and
conduct a search based on the selected information dragged into the search field, wherein the search is specific for the information type.

10. The computer readable storage media of claim 9, wherein the instructions operable to automatically identify the information type comprise instructions operable to:
automatically identify the information as text.

11. The computer readable storage media of claim 9, wherein the instructions operable to automatically identify the information type comprise instructions operable to:
automatically identify the information as an image or an image portion.

12. The computer readable storage media of claim 11, further comprising instructions operable to:
determine that part of the image or image portion includes an image-based text representation;
convert the image-based text representation into actual text; and
conduct a text search of the search space using the actual text obtained through the conversion.

13. The computer readable storage media of claim 11, further comprising instructions operable to:
determine whether a search engine associated with the search field supports image searching.

14. The computer readable storage media of claim 9, wherein the instructions operable to detect that the user has selected information displayed at the electronic device comprise instructions operable to:
detect touch inputs at a touch screen of the electronic device.

15. The computer readable storage media of claim 9, wherein the instructions operable to detect that the user has dragged the selected information to the search field comprise instructions operable to:
detect that the user has dragged the selected information to a point near the beginning of the search field so as to cause information present in the search field to be replaced by the selected information.

16. The computer readable storage media of claim 9, wherein the instructions operable to detect that the user has dragged the selected information to the search field comprise instructions operable to:
detect that the user has dragged the selected information to a point near the end of the search field so as to cause the selected information to be appended to information present in the search field.
